(19) United States
(12) Patent Application Publication
(10) Pub. No.: US 2025/0214471 A1
(43) Pub. Date: Jul. 3, 2025

(54) CHARGING CIRCUIT AND METHOD FOR CHARGING A TRACTION BATTERY, ELECTRIC VEHICLE

(71) Applicant: Robert Bosch GmbH, Stuttgart (DE)

(72) Inventor: Gholamabas Esteghlal, Stuttgart -Weilimdorf (DE)

(21) Appl. No.: 18/848,213

(22) PCT Filed: Feb. 27, 2023
(86) PCT No.: PCT/EP2023/054803

§ 371 Date: Sep. 18, 2024

(30) Foreign Application Priority Data
Apr. 1, 2022 (DE) 10 2022 203 233.0

(51) Int. Cl. B60L 53/62; B60L 53/20; H02J 7/02

(52) U.S. Cl. CPC B60L 53/62; B60L 53/20; H02J 7/02; B60L 2210/30; H02J 2207/20

(57) ABSTRACT

The invention relates to the charging of a traction battery by means of AC voltage, wherein a frequency of the AC voltage used for this purpose is taken into account during the charging. An initial starting value is used in order to determine the frequency of the AC voltage. This initial starting value can be provided by a non-volatile memory.

### BACKGROUND

The present invention relates to a charging circuit as well as a method for charging a traction battery. The present invention also relates to an electric vehicle with such a charging circuit.

Fully or at least partially electrically powered vehicles have an electrical energy store, also known as a traction battery. This traction battery can provide the electrical energy to propel the electric vehicle. Moreover, such a traction battery may also be recharged by an external power source. Charging can generally be carried out by means of DC voltage (DC) or AC voltage (AC). If charging is carried out by means of a single-phase or multi-phase AC voltage, a charging circuit is required that converts the AC voltage to a DC voltage and, if necessary, adjusts the voltage level. In particular, when the AC voltage is provided by an electrical power supply network, pre-determined framework conditions for the influence on the power network during charging of the traction battery are to be considered.

For example, publication DE 10 2009 050 042 A1 describes a charging station for electric vehicles. In this context, a grid stabilization is proposed. In particular, the grid stabilization is to be achieved by determining a grid frequency and load regulation taking place as a function of the determined grid frequency.

### SUMMARY

The present invention discloses a charging circuit and a method for charging a traction battery and an electric vehicle with the features of the independent claims. Further advantageous embodiments are the subject matter of the dependent claims.

The following is therefore provided:
A charging circuit for charging a traction battery having a detector means and a control means. The detector means is configured to determine a frequency of an AC voltage applied to an input terminal of the charging circuit. The control means is configured to adjust at least one of the operational properties of the charging circuit using the detected frequency of the AC voltage at the input terminal. The detector means is further configured to determine the frequency of the AC voltage at the input terminal using an initial starting value. For this purpose, the detector means comprises a non-volatile memory. This non-volatile memory is configured to store a frequency of the AC voltage detected by the detector means at the input terminal. Furthermore, the memory is configured to provide the stored value of the detected frequency as the initial value for a determination of the grid frequency.

The following is furthermore provided:
An electric vehicle having a traction battery and a charging circuit according to the invention for charging the traction battery.

Finally, the following is provided:
A method for charging a traction battery. The method comprises a step of determining a frequency of an AC voltage applied to an input terminal. The frequency of the AC voltage at the input terminal is determined using a provided initial starting value. The initial starting value may be provided from a non-volatile memory. The method further comprises a step of providing at least one operational property of a charging circuit for charging the traction battery. The at least one operational property is adjusted using the detected frequency of the AC voltage at the input terminal. Furthermore, the method comprises a step of storing the determined frequency of the AC voltage applied to the input terminal in the non-volatile memory. The value of the determined frequency stored in the non-volatile memory in this way thus serves as a future initial starting value for a further determination of the frequency of the AC voltage at the input terminal at a later time.

The present invention is based on the recognition that it may be necessary to know the grid frequency, i.e., the frequency of the AC voltage provided by the power supply network, for the operation of a charging circuit for charging a traction battery by means of an AC voltage from a power supply network. Based on this grid frequency, the operating behavior of the charging circuit may be controlled or regulated. This allows, for example, to minimize feedbacks of the charging circuit into the power supply network during charging of the traction battery.

Furthermore, it is a finding of the present invention that not all electrical power supply networks worldwide operate at the same grid frequency.

It is therefore an idea of the present invention to improve the determination of a grid frequency by the charging circuit of an electric vehicle in that the determination of a grid frequency is not carried out from an arbitrary starting value, but rather a value of a previously determined grid frequency is used as the initial starting value to determine the grid frequency. In this way, it can be achieved that the determination of the grid frequency can convert significantly faster.

For example, the determined grid frequency may be used to control the operating behavior of the charging circuit, which converts an electric AC voltage from an energy supply network to a DC voltage for charging the traction battery. For example, the determined grid frequency may be used to adjust a phase shift between an electrical current and an electrical voltage. The reactive power share can thereby be adjusted. In particular, based on the determined grid frequency, the operating behavior of the charging circuit may be adjusted to minimize the reactive power share and thus minimize a phase shift between electrical current and electrical voltage. In this way, the charging circuit represents an at least approximately resistive load in relation to the connected power supply network.

Although power supply networks are typically operated at at least approximately the same grid frequency, it is still possible that, due to regional differences, an electric vehicle may be connected to power supply networks having different grid frequencies. Thus, it is possible that the underlying grid frequency for a charging circuit may at least occasionally change. However, if the determination of the underlying grid frequency were always started from the same fixed predetermined grid frequency, this would lead to the grid frequency always taking significantly longer to be reliably determined, particularly in areas with a different grid frequency.

According to the present invention, it is therefore possible to adjust the initial grid frequency underlying the determination of the respective current grid frequency. In particular, the previously determined grid frequency can always be used as the initial start variable. Thus, a very rapid determination of the respective grid frequency can take place until the vehicle is to be charged for the first time in a region with a different grid frequency.

According to one embodiment, the detector means comprises a proportional integral (PI) regulator to determine the frequency at the input terminal of the charging circuit. The PI regulator may be configured to determine the frequency of the AC voltage at the input terminal using a comparison of the initial value for determining the grid frequency with a control variable. In this way, the initial starting value for determining the grid frequency may be considered a type of pilot value. In order to further determine the exact grid frequency, it is only necessary to determine a deviation from this initial variable. If the current grid frequency corresponds to at least approximately the respective current grid frequency, the grid frequency can be determined very quickly in this manner.

According to one embodiment, the charging circuit comprises a positioning means. The positioning means is configured to determine a geographic position. For example, a position may be determined using a satellite-assisted navigation system, such as GPS, Galileo, etc. Thus, the detector means may perform the determination of the frequency of the AC voltage at the input terminal using the determined geographic position. In this case, it is also possible to store corresponding variables for different geographic positions for an initial starting value for determining the AC voltage at the input terminal of the charging circuit and to use them to determine the grid frequency. Thus, even with regular use of charging points with different grid frequencies, the respective applied grid frequency can be determined very quickly.

According to one embodiment, the detector means is configured to store a current value of the frequency of the AC voltage at the input terminal as a new initial value in a non-volatile memory if a predetermined storage condition is satisfied. For example, such a predetermined storage condition may comprise a condition that the determined grid frequency is within a predetermined range of values over a predetermined period of time. In this way, a new initial variable for a starting value for determining the grid frequency can be stored in the non-volatile memory if a stable frequency has been determined during the determination of the respective currently valid grid frequency.

According to one embodiment, the control means is configured to adjust a phase shift between current and voltage using the detected frequency of the AC voltage on the input terminal. In particular, a phase shift between current and voltage can be minimized. In this way, a reactive power share may be minimized so that only active power is substantially drawn from the charging circuit.

The above embodiments and further developments can be combined with one another in any desired manner insofar as advantageous. Additional embodiments, further developments, and implementations of the invention also include inventive feature combinations not described or explicitly specified hereinabove or hereinafter with respect to exemplary embodiments. The skilled person will in particular also add individual aspects as improvements or additions to the respective basic forms of the invention.

### BRIEF DESCRIPTION OF THE DRAWINGS

Further features and advantages of the invention are explained hereinafter with reference to the drawings. Shown are:

FIG. 1 a schematic diagram illustrating the charging of the traction battery of an electric vehicle with a charging circuit, in accordance with one embodiment;

FIG. 2 a block diagram of a charging device according to a further embodiment; and

FIG. 3 a flow chart that forms the basis for a method for charging a traction battery according to one embodiment.

### DETAILED DESCRIPTION

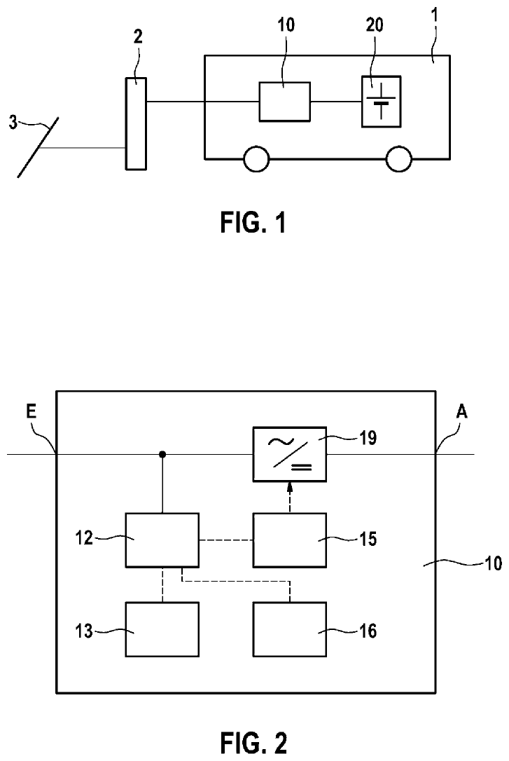

FIG. 1 shows a schematic representation of a diagram illustrating a charging process for charging a traction battery 20 in an electric vehicle 1. To charge the traction battery 20, the electric vehicle 1 can be parked at a charging station 2. The charging station 2 can then be electrically connected to a charging circuit 10 of the electric vehicle 1. Electrical energy from a power supply network 3 can then be provided via the charging station 2 at the charging circuit 10 of the vehicle 1. If a single-phase or multi-phase AC voltage is provided from the charging station 2, this AC voltage can be converted by the charging circuit 10 to a DC voltage. Furthermore, the voltage level of the DC voltage provided by the charging circuit 10 at the voltage level may be adjusted to be suitable for charging the traction battery 20.

For charging the traction battery 20 in the vehicle 1, it is desirable that as much active power as possible is transmitted from the charging station 2 to the electric vehicle 1. In order to keep the reactive power share as low as possible, electrical current and electrical voltage should therefore be at least approximately in phase. In order to achieve such an operating behavior, it may be necessary for the electrical base frequency of the AC voltage provided by the charging station 2 to be known or determined in the charging circuit 10. In this case, it is desirable to determine the base frequency of the provided AC voltage as quickly as possible. For such a determination of the base frequency of an AC voltage, it is advantageous to begin the determination of the base frequency from an initial starting value, which is as close as possible to the base frequency of the AC voltage. However, as there are different energy supply networks worldwide, some of which have different base frequencies, it is not possible to provide a standardized initial value for determining the base frequency that represents an optimum for all applications. Thus, the charging circuit 10 may adjust the value of the initial frequency to determine the base frequency of an AC voltage provided to an input terminal.

FIG. 2 shows a block diagram of a charging circuit 10 according to one embodiment. An electrical AC voltage can be provided to an input terminal E. This may be, for example, a single-phase or multi-phase electric AC voltage as provided by a charging station 2. This electric AC voltage provided at input terminal E may be converted to a DC voltage suitable for charging a traction battery 20 of the vehicle by means of a voltage converter 19. The voltage converter 19 can be controlled accordingly by a control means 15. As already mentioned above, the voltage converter 19 should be controlled in such a way that the phase difference between the electrical voltage and the electrical current of the electrical power flowing into the voltage converter 19 is as small as possible. In this way, the reactive power share can be minimized. Knowledge of the respective base frequency of the AC voltage provided to the input terminal E may be required for such control. For this purpose, a detector means 12 may be provided in the charging circuit 10, which determines the base frequency of the AC voltage provided to the input terminal E. An initial starting value can be used to determine the electrical frequency of the AC voltage provided to the input terminal E.

Preferably, the initial starting value may be a value that approaches the frequency of the AC voltage to be analyzed as close as possible. Since conventional approaches already exist for determining the base frequency of an AC voltage using an initial starting value, these will not be explained in more detail here. However, in order to take account of the fact that different energy supply networks with different base frequencies exist worldwide, the initial starting value for determining the grid frequency can be adjusted. For example, a previously determined value for the base frequency of the AC voltage provided to input terminal E can be stored as the initial starting value in a non-volatile memory 13. This saved value can be read from the non-volatile memory 13 for a new determination of the frequency of the AC voltage at the input terminal E and used as the new initial starting value. In this way, a suitable initial starting value is used as long as the vehicle 1 with the charging circuit 10 described is in a range with a corresponding grid frequency. If such a vehicle is first connected to an electric AC voltage with a different electrical frequency, a new initial value can be stored in the non-volatile memory 13 after a corresponding detection of the different frequency. The new initial value for determining the frequency of the AC voltage as the new starting value is then available in the non-volatile memory 13. Accordingly, a suitable initial starting value may be used for determining the electrical frequency of the AC voltage in further charging operations.

In addition, it is also possible to determine a geographic position of the vehicle 1 with the described charging circuit 10 by means of a corresponding positioning means 16.

Accordingly, the determined geographic position may also be considered to determine a respective suitable initial starting value for determining the frequency of an AC voltage provided to input terminal E. Such a positioning device 16 can be a satellite navigation system, for example GPS, Galileo or the like. In addition, any other positioning means are possible as well. Accordingly, it is possible to store a plurality of initial starting values with corresponding geographic positions in the non-volatile memory 13. Depending on the current geographic position, a suitable initial starting value for determining the frequency of the electrical AC voltage at the input terminal E can then be read and used in the non-volatile memory 13.

In principle, it is possible to save the determined value as a new initial value in the non-volatile memory 13 after each determination of the respective current frequency of the AC voltage at the input terminal E. Moreover, it is also possible to link the storage of a suitable initial value for determining the frequency to further conditions. For example, an initial value for determining the frequency may also only be stored in the non-volatile memory 13 if a predetermined period of time has elapsed since the last storage and/or the last determination of a value for the frequency of the AC voltage at the input terminal E.

Furthermore, if necessary, a new initial value can also only be stored in the non-volatile memory 13 if further predetermined conditions are satisfied for determining the current frequency. For example, such a condition may comprise the condition that the determined frequency is within a predetermined range of values over a predetermined period of time, for example maximum ±1%.

Furthermore, the conditions for storing a new initial value in the non-volatile memory 13 may also take into account an amplitude or an effective value of the grid voltage. For example, a new initial value may only be stored in the non-volatile memory 13 if the value of the electrical voltage at input terminal E is within a predetermined value range. Similarly, only such initial values for the frequency of an electrical voltage can be stored in the non-volatile memory 13, which satisfy predetermined conditions. For example, multiple frequency ranges may be defined that specify valid frequency ranges for grid frequencies of power supply networks. Such frequency ranges may comprise, for example, 50 Hz and 60 Hz, wherein tolerance ranges, for example ±1 Hz or the like, are also possible for such specific frequencies.

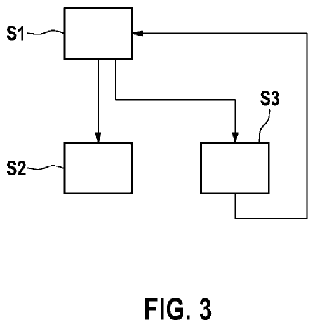

FIG. 3 shows a flow diagram of a method for charging a traction battery in an electric vehicle 1. The method can generally comprise any desired steps, as already previously described in connection with the electric vehicle 1 or a charging circuit for charging the traction battery 20. Similarly, the charging circuit 10 described above for charging the traction battery 20 may also comprise any components as described below in connection with the method.

In step S1, a frequency of an AC voltage applied to an input terminal E is determined. The frequency of the AC voltage at the input terminal E is in particular determined using a provided initial starting value. This initial starting value may be stored in a non-volatile memory 13 and provided to determine the frequency.

In step S2, an operational property for charging the traction battery 20 is adjusted using the detected frequency of the AC voltage at the input terminal E. In particular, adjusting such an operational property may comprise controlling a voltage converter 19. The voltage converter 19 can be controlled in such a way that a phase difference between electrical current and electrical voltage is minimized at the input terminal E. In this way, a reactive power share can be minimized. By this, it can be achieved that an active power share as high as possible is obtained for the charging of the traction battery 20.

Furthermore, the method may comprise a step S3 of storing the determined frequency of the AC voltage applied to the input terminal E in the non-volatile memory 13. The value stored in this way may be used as the new initial starting value for a further detection of the frequency of the AC voltage at input terminal E.

In summary, the present invention relates to the charging of a traction battery by means of AC voltage, wherein a frequency of the AC voltage used for this purpose is taken into account during the charging. An initial starting value is used in order to determine the frequency of the AC voltage. This initial starting value can be provided by a non-volatile memory. In particular, the initial starting value can be adjusted in the non-volatile memory if the detection of the frequency of the AC voltage results in a value different from this value.

1. A charging circuit (10) for charging a traction battery (20), the charging circuit comprising:
a detector (12) which is configured to determine a frequency of an AC voltage applied to an input terminal (E) of the charging circuit (10); and
a controller (15) which is configured to adjust operational properties of the charging circuit (10) using the detected frequency of the AC voltage at the input terminal (E),
wherein the detector (12) is configured to determine the frequency of the AC voltage at the input terminal (E) using an initial starting value, and wherein the detector (12) comprises a non-volatile memory (13) which is configured to store a frequency of the AC voltage at the input terminal (E) detected by the detector (12) and to provide the initial value for determining the grid frequency.

2. The charging circuit (10) according to claim 1, wherein the detector (12) comprises a proportional-integral regulator which is configured to determine the frequency of the AC voltage at the input terminal (E) using a comparison of the initial value for determining the grid frequency with a control variable.

3. The charging circuit (10) according to claim 1, with a positioning means (16) which is configured to determine a geographic position and to perform a determination of the frequency of the AC voltage at the input terminal (E) using the determined geographic position.

4. The charging circuit (10) according to claim 1, wherein the detector meansdetector (12) is configured to store a current value of the frequency of the AC voltage at the input terminal (E) as a new initial value in the non-volatile memory (13) if a predetermined storage condition is satisfied.

5. The charging circuit (10) according to claim 4, wherein the predetermined storage condition comprises an at least approximately constant frequency over a predetermined period of time.

6. The charging circuit (10) according to claim 1, wherein the control meanscontroller (15) is configured to adjust a phase shift between current and voltage using the detected frequency of the AC voltage on the input terminal (E).

7. The charging circuit (10) according to claim 6, with a voltage transformer (19) configured to convert the electric voltage provided at the input terminal to a DC voltage suitable for recharging the traction battery (20).

8. An electric vehicle (1) comprising:
a traction battery (20),
a charging circuit (10) for charging a traction battery (20) according to claim 1.

9. A method for charging a traction battery (20), comprising the steps of:
determining (S1) a frequency of an AC voltage applied to an input terminal (E), wherein the frequency of the AC voltage at the input terminal (E) is determined using a provided initial starting value, and wherein the initial starting value is stored in a non-volatile memory (13);
adjusting (S2) operating properties for charging the traction battery (20) using the detected frequency of the AC voltage at the input terminal (E); and
storing (S3) the determined frequency of the AC voltage applied to the input terminal (I) in the non-volatile memory (13) as the future initial starting value.
